(19) United States
(12) Patent Application Publication
(10) Pub. No.: US 2012/0188789 A1
(43) Pub. Date: Jul. 26, 2012

(54) BACKLIGHT DEVICE AND IMAGE DISPLAY DEVICE

(75) Inventor: Shigehiro MASUJI, Tokyo-to (JP)

(73) Assignee: JVC KENWOOD CORPORATION, Yokohama-shi (JP)

(21) Appl. No.: 13/353,897

(22) Filed: Jan. 19, 2012

(30) Foreign Application Priority Data
Jan. 21, 2011 (JP) 2011-010920

(51) Int. Cl. F21V 8/00

(52) U.S. Cl. 362/602

(57) ABSTRACT

The backlight device includes: a light guide plate having a rectangular shape; LEDs arranged on end surfaces of side surface portions formed of long and short sides of the light guide plate; and LED board having a long and thin shape and on which the LEDs are mounted, wherein a plurality of LED boards of a same type are arranged on the long and short sides of the light guide plate, and the plurality of LED boards are continuously arranged corresponding to the entire area of the end surface of each side of the light guide plate, and at the same time, the LED boards of any one of long and short sides are not arranged but a predetermined interval is formed at an edge portion constituting a point of contact between the long and short sides of the light guide plate.

### CROSS-REFERENCE TO RELATED PATENT APPLICATIONS

This application claims the benefit of Japanese Patent Application No. 2011-010920, filed on Jan. 21, 2011, in the Japan Patent Office, the disclosure of which is incorporated herein in its entirety by reference.

### BACKGROUND OF THE INVENTION

1. Field of the Invention

The present invention relates to a backlight device and an image display device, and more particularly, to a backlight device which irradiates light from a rear surface of a display panel by introducing light through a side surface (end surface) of a light guide plate by using a plurality of point light sources, such as light emitting diodes (LEDs), and an image display device.

2. Description of the Related Art

Recently, an image display device (for example, a display device or a television set) which displays an image by using a display module such as a liquid crystal panel has been rapidly supplied.

Generally, an image display device includes a display panel unit (body of image display device) which includes a display module and a case body in which the display module is accommodated and in which an image display surface of the display module is exposed to be seen from the outside, and a stand (pedestal unit) which supports the display panel unit such that neck movement or the like is possible.

A backlight is required in a liquid crystal module where a liquid crystal panel is used as a display module, and for example, a linear light source, such as a cold cathode tube (cold cathode fluorescent lamp (CCFL)) or an external electrode fluorescent tube (external electrode fluorescent lamp (EEFL)), or a light emitting diode (LED) light source using an LED is used as a backlight light source.

However, recently, with an increase in a size of a screen, thinning or weight lightening is required to decrease a thickness of a body of an image display device as much as possible. For thinning or weight lightening of a body of an image display device, a display module or an inner part of a case body occupying most of volume or weight inside the body of the image display device may be thinned or weight-lightened. In order to thin a display module, it is important to thin a backlight device as well.

In order to thin a backlight, various backlight systems using edge-light type in which light sources are arranged on end surfaces of a light guide plate are being suggested, instead of a conventional backlight system using a direct type of arranging light sources on a rear surface of a liquid crystal panel. As such, by arranging light sources on end surfaces of a light guide plate, it is possible to suppress a thickness of a backlight from increasing due to the light sources.

In a conventional edge-light backlight system, a backlight where LEDs are arranged on end surfaces of a light guide plate as light sources is disclosed, for example, in Patent Document 1. In such a backlight using LEDs as light sources, a plurality of LEDs are arranged on end surfaces of a light guide plate at predetermined intervals. Also, in order to suppress a temperature increase of LEDs, a heat-radiating structure is used.

However, in the conventional structure disclosed in Patent Document 1, when LED light sources are arranged on an end surface of only one side of a light guide plate, a size of a heat-radiating structure is increased if a quantity of light introduced to the light guide plate is to be increased, and thus expenses are increased.

Also, as disclosed in paragraphs [0005] and [0006] of conventional Patent Document 1, if the temperature of each of LEDs is not uniform during lighting, luminance may be uneven in a part of a backlight. Also, when heat-radiating efficiency is low, a degree of luminance unevenness is deteriorated.

Specifically, if LED light sources are arranged on end surfaces of at least two sides of a light guide plate, a quantity of light is concentrated at four corners of a backlight, i.e., edge portions of four corners of the light guide plate, and thus heat is also easily concentrated thereat compared to other locations. Accordingly, driving efficiency of an LED is decreased. As a result, light sources are quickly changed with passage of time at edge portions of four corners of a backlight, and thus a product lifetime of a backlight device or image display device is reduced.
(Patent Document 1) Japanese Laid-Open Patent Publication No. 2004-233810

### SUMMARY OF THE INVENTION

The present invention provides a backlight device and an image display device in an edge-light backlight system where light emitting diodes (LEDs) are used as a light source, where thinning of a backlight or image display device or a multiscreen having a narrow edge and a symmetric structure is realized by efficiently arranging LEDs on end surfaces of a light guide plate, and at the same time, a long lifetime of the backlight or a liquid crystal panel is realized by satisfactorily maintaining operation temperature conditions of LED light sources or a driver board of the liquid crystal panel and making a change of a liquid crystal module with passage of time uniform in overall.

According to an aspect of the present invention, there is provided a backlight device including: a light guide plate having a rectangular shape; light sources arranged on end surfaces of side surface portions formed of long and short sides of the light guide plate; and a mounting board having a long and thin shape and on which the light sources are mounted, wherein a plurality of the mounting boards of a same type are arranged on the long and short sides, and the plurality of mounting boards are continuously arranged corresponding to the entire area of the end surface of each side of the light guide plate, and at the same time, the mounting boards of any one of long and short sides are not arranged but a predetermined interval is formed at an edge portion constituting a point of contact between the long and short side of the light guide plate.

According to another aspect of the present invention, there is provided a backlight device including: a light guide plate having a rectangular shape; light sources arranged on each of end surfaces of side surface portions including one long side and one or two short sides of the light guide plate; and a mounting board having a long and thin shape and on which the light sources are mounted, wherein a plurality of mounting boards of a same type are arranged on the one long side and the one or two short sides, and the plurality of mounting boards are continuously arranged corresponding to the entire side length area of the one long side.

According to another aspect of the present invention, there is provided a backlight device including: a light guide plate having a rectangular shape; light sources arranged on each of end surfaces of side surface portions including one short side and one or two long sides of the light guide plate; and a mounting board having a long and thin shape and on which the light sources are mounted, wherein a plurality of mounting boards of a same type are arranged on the one short side and the one or two long sides, and the plurality of mounting boards are continuously arranged corresponding to the entire side length area of the one short side.

### BRIEF DESCRIPTION OF THE DRAWINGS

The above and other features and advantages of the present invention will become more apparent by describing in detail exemplary embodiments thereof with reference to the attached drawings in which:

FIG. 1 is a perspective view of an entire configuration of an image display device according to an embodiment of the present invention;

FIG. 2 is an exploded view for describing an image display device according to an embodiment of the present invention;

FIG. 3 is a perspective view for describing a light emitting diode (LED) board in an image display device, according to an embodiment of the present invention;

FIG. 4 is a cross-sectional perspective view for describing an adhesion structure of an LED board and an image display device, according to an embodiment of the present invention;

FIG. 5 is a partial cross-sectional view of an image display device according to an embodiment of the present invention;

FIG. 6 is a view of a configuration of essential parts according to a first embodiment of the present invention;

FIG. 7 is a view of a configuration of essential parts according to the first embodiment of the present invention;

FIG. 8 is a view of a configuration of essential parts according to a second embodiment of the present invention;

FIG. 9 is a view of a configuration of essential parts according to the second embodiment of the present invention;

FIG. 10 is a view of a configuration of essential parts according to a third embodiment of the present invention; and

FIG. 11 is a view of a configuration of essential parts according to the third embodiment of the present invention.

### DETAILED DESCRIPTION OF THE INVENTION

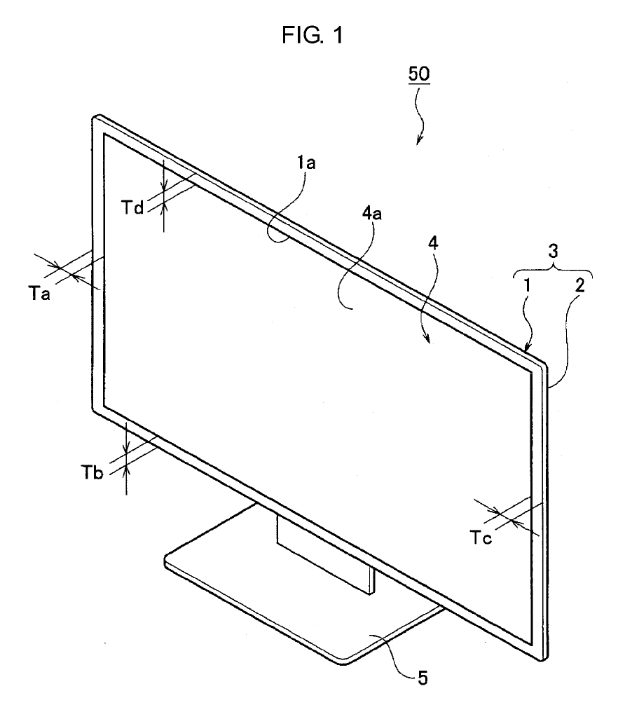

Hereinafter, the present invention will be described in detail by explaining exemplary embodiments of the invention with reference to FIGS. 1 through 11.

FIG. 1 is a perspective view of an overall configuration of an image display device 50 according to an embodiment of the present invention, which is viewed from a front upper right side of the image display device 50. Here, a side where a display screen is seen is referred to as the front.

The image display device 50 according to the present embodiment is a monitor which displays an externally inputted image signal. Also, a screen size is assumed to be a large size of at least 30 inch type, and the present embodiment describes about a case of 42 inch type. Also, a liquid crystal panel is used as a display panel.

In FIG. 1, the image display device 50 includes a case body 3 where a front case body 1 having a frame shape and a rear case body 2 are combined to each other.

The case body 3 accommodates a liquid crystal panel 4, and a display surface 4a constituting an image display unit of the liquid crystal panel 4 is externally exposed through an opening 1a having a rectangular shape formed in the front case body 1.

Also, the case body 3 is supported by a stand 5 adhered to a rear surface (inside of the drawing sheet of FIG. 1) of the case body 3, and the image display device 50 is provided on a floor or the like. Alternatively, the stand 5 may be removed and a hanging tool may be adhered to the case body 3 so that only the case body 3 may hang on a ceiling or be mounted on a wall.

The front case body 1 has a frame shape and has a symmetric structure where edge widths Ta through Td of four sides have the same width (length) up and down, and left and right. Also, a remote control light receiving window unit (not shown) is formed at a right bottom portion of the front case body 1.

Although not shown, an LED-DRV board on which a drive circuit for driving an LED light source is mounted, or a timing controller board for controlling display of the liquid crystal panel 4, is provided under a rear surface of the rear case 2 of the image display device 50. In addition, although it is not shown, a circuit board for signal processing of the image display device 50 or the like, or a power supply unit is provided, wherein various circuit boards or the power supply unit is entirely covered by a circuit board cover.

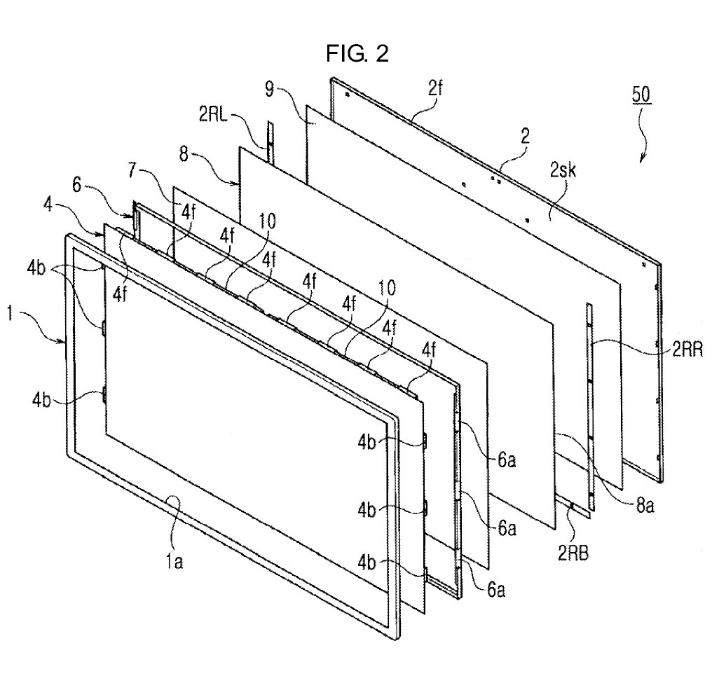

FIG. 2 is an exploded view for describing the image display device 50 according to an embodiment of the present invention.

The image display device 50 includes, as ordered from the front, the front case body 1, the liquid crystal panel 4, a panel chassis 6, an optical sheet unit 7, a light guide plate 8, a reflection sheet 9, and the rear case body 2.

The front case body 1 has a symmetric frame shape, and a rib (not shown) for strengthening rigidity of the front case body 1 is provided inside the frame, and thus heat generated inside the case body 3 is efficiently radiated outside the image display device 50.

Three (3) protruding pieces 4b having a film shape protrude from each of right and left sides of the liquid crystal panel 4.

Also, a pair of LCD-DRV boards 10, on which a circuit for driving the liquid crystal panel 4 is mounted, is connected to a top side end of the liquid crystal panel 4 via flexible boards 4f. Also, the flexible boards 4f and the LCD-DRV boards 10 are fixed by bending to a rear surface side of the rear case body 2 from the top side end of the liquid crystal panel 4.

The panel chassis 6 is provided on a frame by injection-molding resin, and concave portions 6a are formed at locations corresponding to the protruding pieces 4b so as not to interfere with the protruding pieces 4b.

The rear case body 2 includes a base board 2sk, and a bottom rib body 2RB, a left rib body 2RL, and a right rib body 2RR, that is, three rib bodies adhered to the base board 2sk. By using the three rib bodies 2RB, 2RL, and 2RR, rigidity of the rear case body 2 is strengthened, and also heat generated inside the case body 3 is efficiently radiated outside the image display device 50.

The base board 2sk may be formed by, for example, performing a process such as pressing on an aluminum plate having a thickness of 1.0 mm. An end of each of sides is bent toward front side to form a flange unit 2f.

Also, a top rib body may be provided on top of the rear case body 2 to strengthen the rigidity of the rear case body 2, but an LED board 11 to be described later is not adhered to the top rib body. Accordingly, the flexible boards 4f and the LCD-DRV boards 10 are not directly affected by heat generated from the LED board 11.

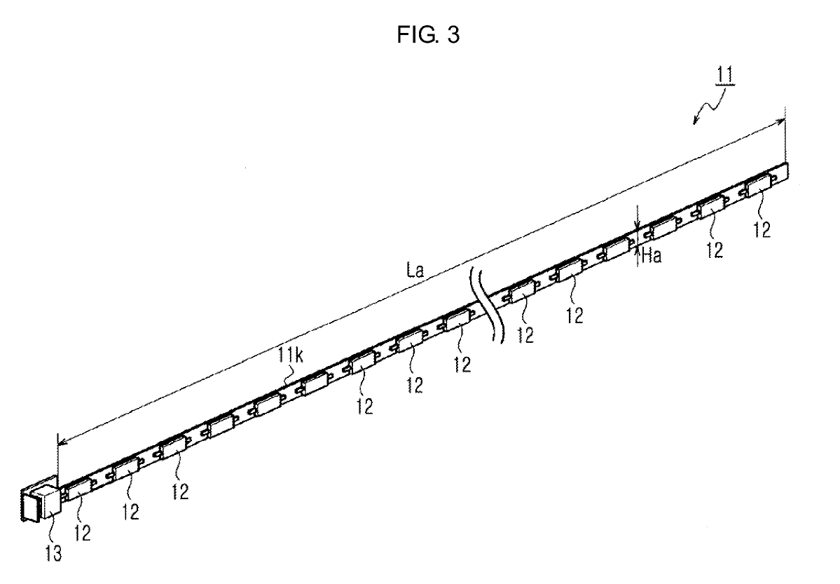

The LED board (mounting board) 11 shown in FIG. 3 is adhered to facing surfaces of the bottom, left, and right rib bodies 2RB, 2RL, and 2RR (sides farther from sides corresponding to adjacent flange unit 2f).

In the LED board 11, a plurality of LEDs 12, as light sources, and a drive circuit for the LEDs are mounted on a base board 11k. Each LED 12 is a white LED. Alternatively, one or more LEDs 12 may be provided on one base board 11k.

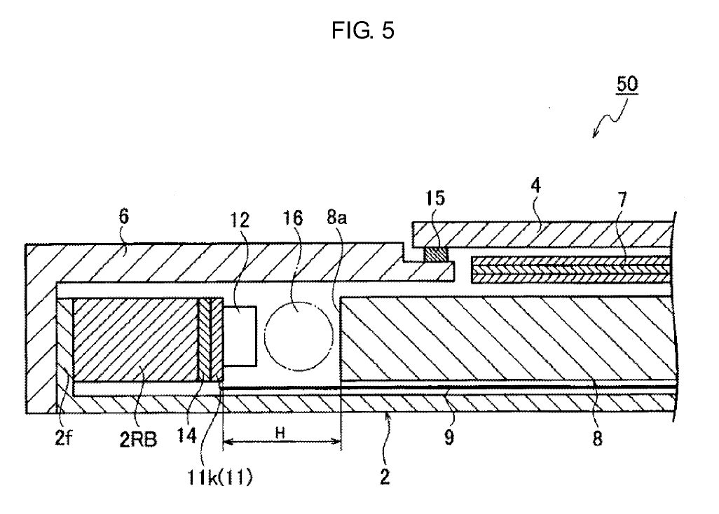

In the image display device 50 according to the present embodiment, the liquid crystal panel 4 emits light as light from the LEDs 12 is incident on an end surface 8a of a side surface portion of the light guide plate 8 (refer to FIG. 5).

Also, the LED board 11 is provided on a total of three sides at locations corresponding to bottom, right, and left sides of the light guide plate 8, and light is introduced to the inside of the light guide plate 8 from each of the three sides.

In detail, the base board 11k has a thin and long shape having a height Ha corresponding to a height of an adhered rib body, and a length La of a mounting portion on which the LEDs 12 are mounted, according to a side length of the light guide plate 8 to which light is introduced.

The plurality of LEDs 12 are arranged at equal pitches to be aligned in a long side direction of the base board 11k.

One anode and one cathode are provided in each LED 12, and each LED 12 is lighted on as a voltage is applied between the anode and the cathode.

Also, a connector 13 to be connected to the LCD-DRV boards 10 is mounted on one end of the base board 11k.

Here, the connector 13 may not be provided on the same plane as the surface of the base board 11k, where the LEDs are mounted the same, but provided on a rear surface of the base board 11k, where the LEDs 12 are not mounted.

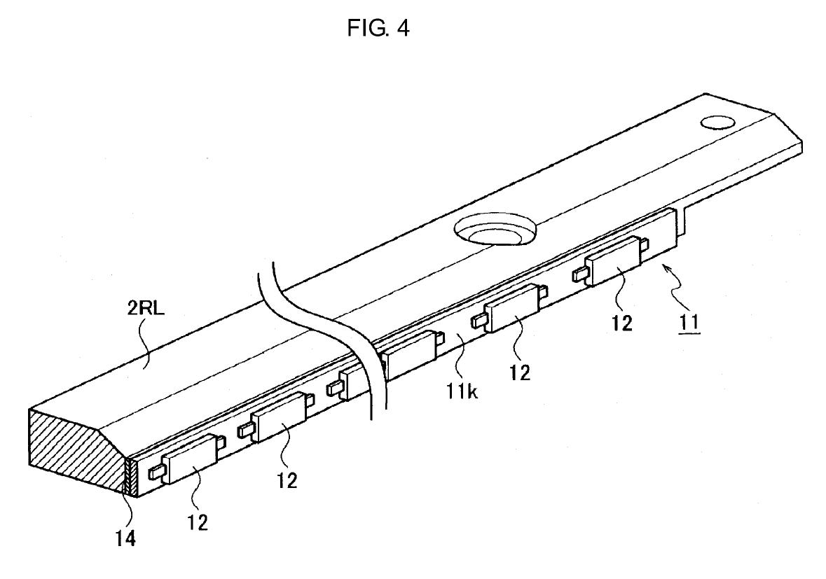

FIG. 4 is a cross-sectional perspective view for describing the LED board 11 adhered to the left rib body 2RL. As shown in FIG. 4, for example, an adhesive tape 14 having a heat-radiating property may be used to attach the LED board 11 to each rib body.

FIG. 5 is a cross-sectional view of the bottom rib body 2RB of the image display device 50 according to an embodiment of the present invention.

The liquid crystal panel 4 is arranged on the panel chassis 6 with a buffer material 15 interposed between them. The light guide plate 8 has a size slightly larger than the display surface 4a that is an effective screen of the liquid crystal panel 4 and is a transparent plate-shaped member formed of acryl or the like. Alternatively, the light guide plate 8 may be formed of another material, such as polycarbonate.

In order to thin the entire image display device 50, the light guide plate 8 has a thickness from about 1 mm to about 5 mm. The light guide plate 8 is arranged on a rear side of the liquid crystal panel 4 so as to cover the entire rear surface of the liquid crystal panel 4. The optical sheet unit 7 is formed by stacking a diffusion sheet, a prism sheet, or the like. The optical sheet unit 7 is disposed between the liquid crystal panel 4 and the light guide plate 8.

As described above, the LED 12 employs a white light emitting diode emitting white light. In detail, the LED 12 includes a fluorescent layer, which emits yellow light by being excited by blue light and is stacked on a light emitting surface of a semiconductor light emitting element that emits blue light. Accordingly, white light that is a composed light of blue light and yellow light is emitted from the LED 12. Alternatively, the LED 12 may include a first fluorescent layer emitting red light by being excited by blue light and a second fluorescent layer emitting green light by being excited by blue light, which are stacked on a light emitting surface of a semiconductor light emitting element that emits blue light. At this time, white light that is a composed light of blue, red, and green lights may be obtained as well. In order to protect the LED 12 from an external environment, the LED 12 may be sealed by a sealing material optically having a low load, for example, a synthetic resin having high transparency in a visible area.

A light mixing portion 16 is formed in a space surrounded by the LEDs 12, the end surface 8a of the light guide plate 8, the panel chassis 6, and the reflection sheet 9. The light mixing portion 16 has a function of introducing light emitted from the LEDs 12 to the end surface 8a of the light guide plate 8 while reducing unevenness of luminosity. Light emitted from the LEDs 12 is directly introduced to the end surface 8a of the light guide plate 8 through the light mixing portion 16, or introduced to the end surface 8a of the light guide plate 8 after being reflected by an inner surface of the panel chassis 6 or by the reflection sheet 9. Light introduced into the light guide plate 8 from the end surface 8a is then diffused and reflected by the reflection sheet 9 and irradiated onto the rear surface of the liquid crystal panel 4 through the optical sheet unit 7, as uniform light. Here, a process such as a dot pattern is performed on a rear surface of the light guide plate 8 so that light from the LEDs 12 is ascended at an angle as close to a right angle to the liquid crystal panel 4 as possible.

The LED 12 functions as a point light source. Accordingly, light incident on the end surface 8a of the light guide plate 8 may have uneven luminosity due to arrangement intervals of the LEDs 12. A distribution of light emitted by the LED 12 is known to be circular. Accordingly, when an interval H from the LED 12 to the light guide plate 8 is varied, luminosity unevenness also varies.

Generally, when the interval H from the LED 12 to the light guide plate 8 is decreased, reduction in luminosity between the LEDs 12 increases, and thus luminosity unevenness increases. Meanwhile, when the interval H from the LED 12 to the light guide plate 8 is increased, luminosity unevenness is decreased, but an average of luminosity of light incident on the end surface 8a of the light guide plate 8 is decreased due to diffusion, absorption, or the like of light in the light mixing portion 16. Accordingly, the interval H is required to be set such that luminosity unevenness and an average of luminosity at the end surface 8a of the light guide plate 8 satisfy required values. If the LEDs 12 are all provided at equal pitches, the interval H where luminosity unevenness is minimum may be employed by varying the interval H.

Also, generally, the image display device 50 is designed such that a screen center portion is brightened. Thus, in real life, display luminance is gradually increased from an outer circumference portion to a center portion of the display surface 4a of the liquid crystal panel 4, so that luminance unevenness is not generated within a display screen of the liquid crystal panel 4. A main method of gradually increasing display luminance may include changing density of a dot pattern or a diameter of a dot on the rear surface of the light guide plate 8, and adjusting light distribution to have good balance throughout the display surface.

As described above, according to the image display device 50 of the present embodiment, the LED boards 11 are arranged on a total of three sides at locations corresponding to the left, right, and bottom sides of the light guide plate 8, and light is introduced to the inside of the light guide plate 8. Thus, the density of the dot pattern or the diameter of dots of the light guide plate 8 is set according to the above specification in which the light is introduced to three sides, thereby the luminance is set.

As such, the dot pattern of the light guide plate 8 may be suitably distributed in a surface of the display screen according to a location of the end surface 8a to which light is introduced or a change of quantity of light introduced to the end surface 8a.

### First Embodiment

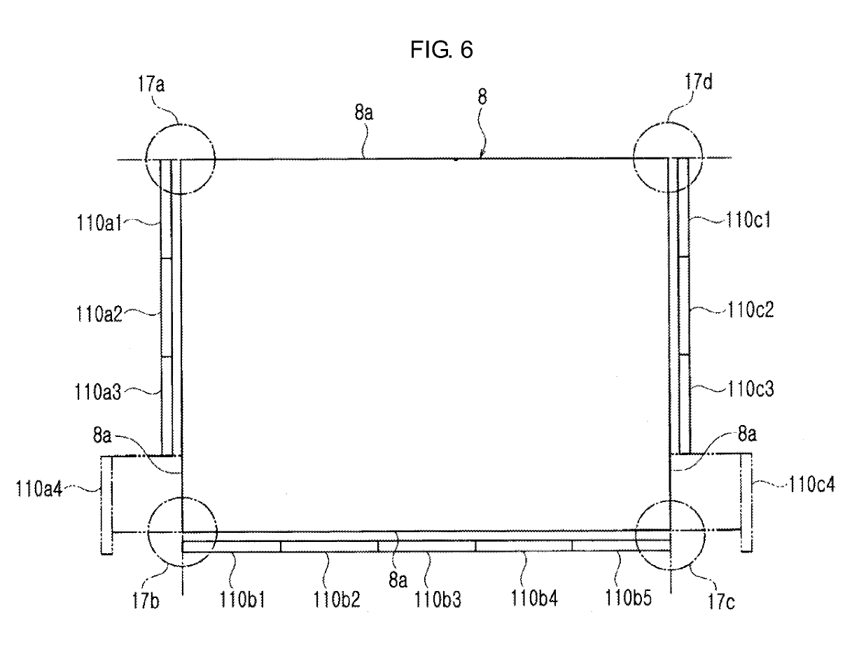

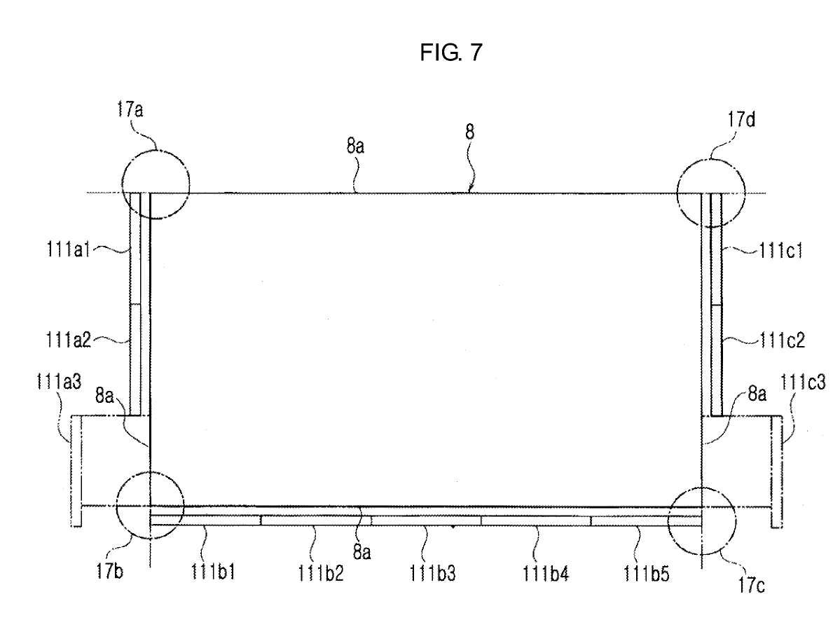

FIGS. 6 and 7 are views of configurations of essential parts according to a first embodiment of the present invention.

In FIGS. 6 and 7, LED boards 11 (generally denoted by reference numerals 110 and 111) on which the LEDs 12 are mounted at equal pitches are arranged facing the end surfaces 8a of side surface portions corresponding to one long side and two short sides of the light guide plate 8.

Also, in FIG. 6, the light guide plate 8 and the display surface 4a of the liquid crystal panel 4 have a width longer than a length, in which a ratio of a long side to a short side is 4:3, and in FIG. 7, the light guide plate 8 and the display surface 4a of the liquid crystal panel 4 have a width longer than a length, in which a ratio of a long side to a short side is 16:9.

In FIG. 6, LED boards 110a1, 110a2, and 110a3 are arranged on the end surface 8a of a side surface portion of a left short side of the light guide plate 8, LED boards 110b1, 110b2, 110b3, 110b4, and 110b5 are arranged on the end surface 8a of a side surface portion of a bottom long side of the light guide plate 8, and LED boards 110c1, 110c2, and 110c3 are arranged on the end surface 8a of a side surface portion of a right short side of the light guide plate 8. Since the LED boards 11(110) use the same board, a mounted number and pitch intervals of the LEDs 12 are also the same.

In FIG. 6, five LED boards 11 are continuously arranged on the entire side length area of the bottom long side of the light guide plate 8, i.e., from an edge portion 17b to an edge portion 17c. Also, three LED boards 11 are continuously arranged on each of the left and right short sides of the light guide plate 8 from points of contact between the left and right short sides and a top long side where a light source is not arranged, i.e., from an edge portion 17a and an edge portion 17d, within a range of lengths below a side length of the short sides from the contact points.

Meanwhile, when an LED board 110a4 is to be arranged by being connected to the LED board 110a3 at the left side of the light guide plate 8, the LED board 110a4 exceeds the side length of the short sides, i.e., reaches an area lower than the edge portion 17b.

The LED board 110b1 of the bottom side is also arranged on the edge portion 17b. Thus, when the LED board 110a4 is arranged up to a location of at least the edge portion 17b, heat concentration due to heat generated by the LEDs 12 occurs near the edge portion 17b, and thus driving efficiency of an LED near the edge portion 17b is decreased compared to LEDs in other locations while the LED near the edge portion 17b is quickly changed with respect to passage of time compared to the LEDs in other locations. Accordingly, luminance unevenness or color unevenness is gradually generated, thereby reducing a product lifetime.

Accordingly, the LED board 110a4 is not arranged by being connected to the LED board 110a3. In other words, the maximum number of LED boards 11 arrangeable by being connected to each other is determined within a range of lengths below the side length of the left short side.

Similarly, an LED board 110c4 is not connected to the LED board 110c3 on the right side of the light guide plate 8, and the maximum number of LED boards 11 arrangeable by being connected to each other is determined within a range of lengths below the side length of the right short side.

Also, although not shown, a reflection film which does not leak light to the outside and reflects light into the light guide plate 8 is adhered to the top side and bottoms of the left and right sides, to which light from the LEDs 12 is not introduced, from among the sides of the light guide plate 8.

In FIG. 7, like FIG. 6, five LED boards 111b1, 111b2, 111b3, 111b4, and 111b5 are continuously arranged on the entire side length area of the bottom long side of the light guide plate 8, i.e., from the edge portion 17b to the edge portion 17c.

Also, two LED boards 111a1 and 111a2 are continuously arranged on the left short side of the light guide plate 8 from the point of contact between the left side and the top long side where a light source is not arranged, i.e., from the edge portion 17a, within a range of lengths below the side length of the short side.

Similarly, two LED boards 111c1 and 111c2 are continuously arranged on the right short side of the light guide plate 8 from the point of contact between the right short side and the top long side where a light source is not arranged, i.e., from the edge portion 17d, within a range of lengths below the side length of the short side.

Also, since the LED boards 11(111) of FIG. 7 use the same board, the mounted number or pitch intervals of the LEDs 12 is also the same.

Meanwhile, when an LED board 111a3 is to be arranged by being connected to the LED board 111a2 at the left side of the light guide plate 8, the LED board 111a3 exceeds the side length of the short side, i.e., reaches an area lower than the edge portion 17b.

The LED board 111b1 of the bottom side is also arranged on the edge portion 17b. Thus, when the LED board 111a3 is arranged up to a location of at least the edge portion 17b, heat concentration due to heat generated by the LEDs 12 occurs near the edge portion 17b, and thus driving efficiency of an LED near the edge portion 17b is decreased compared to LEDs in other locations while the LED near the edge portion 17b is quickly changed with respect to passage of time compared to the LEDs in other locations. Accordingly, luminance unevenness or color unevenness is gradually generated, thereby reducing a product lifetime.

Accordingly, the LED board 111a3 is not arranged by being connected to the LED board 111a2. In other words, the maximum number of LED boards 11 arrangeable by being connected to each other is determined within a range of lengths below the side length of the left short side.

Similarly, an LED board 111c3 is not connected to the LED board 111c2 on the right side of the light guide plate 8, and the maximum number of LED boards 11 arrangeable by being connected to each other is determined within a range of lengths below the side length of the right short side.

Also, like FIG. 6, although not shown, a reflection film which does not leak light to the outside and reflects light into the light guide plate 8 is adhered to the top side and the bottoms of the left and right sides, to which light from the LEDs 12 is not introduced, from among the sides of the light guide plate 8.

### Second Embodiment

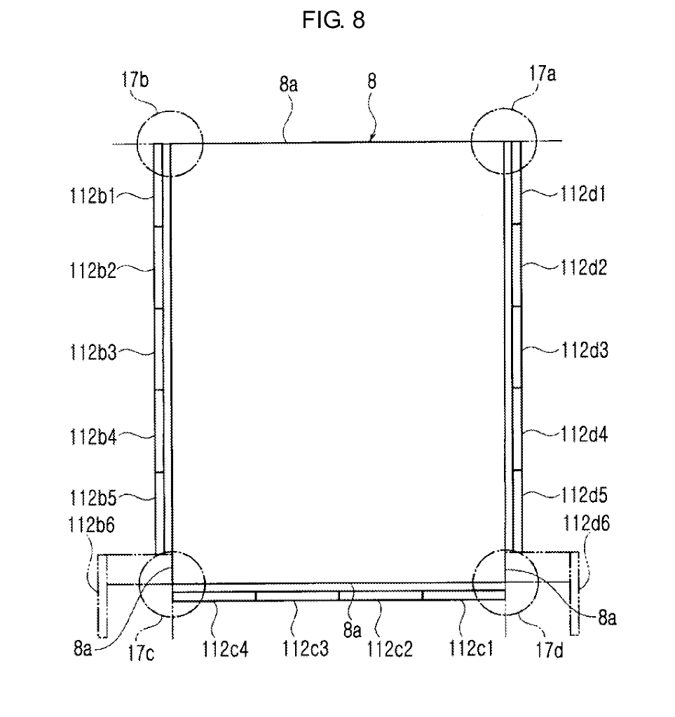

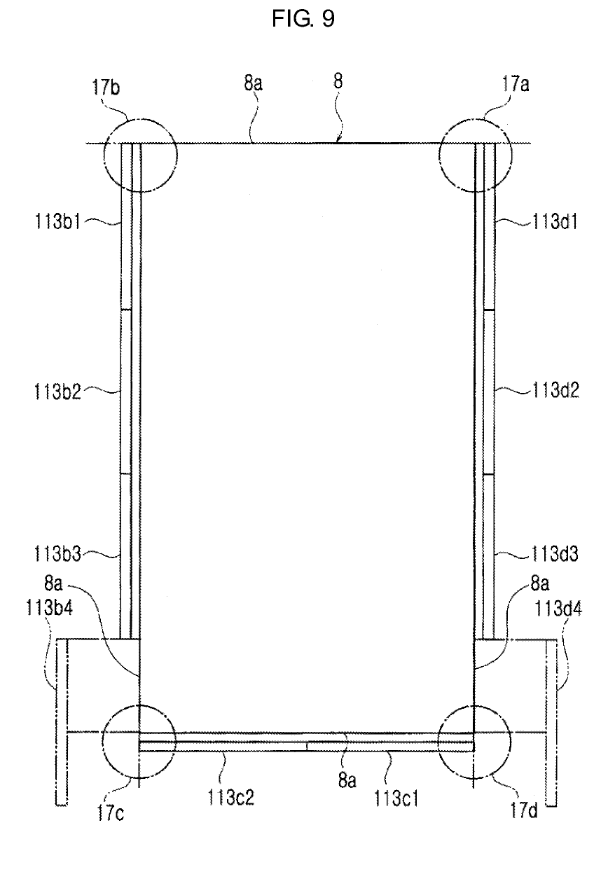

FIGS. 8 and 9 are views of configurations of essential parts according to a second embodiment of the present invention.

In FIGS. 8 and 9, LED boards 11 (generally denoted by reference numerals 112 and 113) on which the LEDs 12 are mounted at equal pitches are arranged facing the end surfaces 8a of side surface portions corresponding to one short side and two long sides of the light guide plate 8.

Also, in FIG. 8, the light guide plate 8 and the display surface 4a of the liquid crystal panel 4 have a length longer than a width, in which a ratio of a long side to a short side is 4:3, and in FIG. 9, the light guide plate 8 and the display surface 4a of the liquid crystal panel 4 have a length longer than a width, in which a ratio of a long side to a short side is 16:9.

FIGS. 8 and 9 are respectively obtained by rotating the light guide plates 8 of FIGS. 6 and 7 by 90° to the right. Hereinafter, the same rules as in FIGS. 6 and 7 are applied to FIGS. 8 and 9, and the same reference numerals used in FIGS. 6 and 7 are partially used for description.

In FIG. 8, LED boards 112b1, 112b2, 112b3, 112b4, and 112b5 are arranged on the end surface 8a of a side surface portion of a left long side of the light guide plate 8, LED boards 112c1, 112c2, 112c3, and 112c4 are arranged on the end surface 8a of a side surface portion of a bottom short side of the light guide plate 8, and LED boards 112d1, 112d2, 112d3, 112d4, and 112d5 are arranged on the end surface 8a of a side surface portion of a right long side of the light guide plate 8. Since the LED boards 11(112) use the same board, the mounted number and pitch intervals of the LEDs 12 are also the same.

In FIG. 8, five LED boards 11 are continuously arranged on the entire side length area of the bottom short side of the light guide plate 8, i.e., from an edge portion 17c to an edge portion 17d. Also, five LED boards 11 are continuously arranged on each of the left and right long sides of the light guide plate 8 from points of contact between the left and right long sides and a top short side where a light source is not arranged, i.e., from an edge portion 17a and an edge portion 17b, within a range of lengths below a side length of the long sides from the contact points.

Meanwhile, when an LED board 112b6 is to be arranged by being connected to the LED board 112b5 at the left side of the light guide plate 8, the LED board 112b6 exceeds the side length of the long side, i.e., reaches an area lower than the edge portion 17c.

The LED board 112c4 of the bottom side is also arranged on the edge portion 17c. Thus, when the LED board 112b6 is arranged up to a location of at least the edge portion 17c, heat concentration due to heat generated by the LEDs 12 occurs near the edge portion 17c, and thus driving efficiency of an LED near the edge portion 17c is decreased compared to LEDs in other locations while the LED near the edge portion 17c is quickly changed with respect to passage of time compared to the LEDs in other locations. Accordingly, luminance unevenness or color unevenness is gradually generated, thereby reducing a product lifetime.

Accordingly, the LED board 112b6 is not arranged by being connected to the LED board 112b5. In other words, the maximum number of LED boards 11 arrangeable by being connected to each other is determined within a range of lengths below the side length of the left long side.

Similarly, an LED board 112d6 is not connected to the LED board 112d5 on the right side of the light guide plate 8, and the maximum number of LED boards 11 arrangeable by being connected to each other is determined within a range of lengths below the side length of the right long side.

Also, although not shown, a reflection film which does not leak light to the outside and reflects light into the light guide plate 8 is adhered to the top side and bottoms of the left and right sides, to which light from the LEDs 12 is not introduced, from among the sides of the light guide plate 8.

In FIG. 9, like FIG. 8, two LED boards 113c1 and 113c2 are continuously arranged on the entire side length area of the bottom short side of the light guide plate 8, i.e., from the edge portion 17c to the edge portion 17d.

Also, three LED boards 113b1, 113b2, and 113b3 are continuously arranged on the left long side of the light guide plate 8 from the point of contact between the left side and the top short side where a light source is not arranged, i.e., from the edge portion 17b, within a range of lengths below the side length of the long side.

Similarly, three LED boards 113d1, 113d2, and 113d3 are continuously arranged on the right long side of the light guide plate 8 from the point of contact between the right side and the top short side where a light source is not arranged, i.e., from the edge portion 17a, within a range of lengths below the side length of the long side.

Also, since the LED boards 11(113) of FIG. 9 use the same board, the mounted number or pitch intervals of the LEDs 12 is also the same.

Meanwhile, when an LED board 113b4 is to be arranged by connecting to the LED board 113b3 at the left side of the light guide plate 8, the LED board 113b4 exceeds the side length of the long side, i.e., reaches an area lower than the edge portion 17c.

The LED board 113c2 of the bottom side is also arranged on the edge portion 17c. Thus, when the LED board 113b4 is arranged up to a location of at least the edge portion 17c, heat concentration due to heat generated by the LEDs 12 occurs near the edge portion 17c, and thus driving efficiency of an LED near the edge portion 17c is decreased compared to LEDs in other locations while the LED near the edge portion 17c is quickly changed with respect to passage of time compared to the LEDs in other locations. Accordingly, luminance unevenness or color unevenness is gradually generated, thereby reducing a product lifetime.

Accordingly, the LED board 113b4 is not arranged by being connected to the LED board 113b3. In other words, the maximum number of LED boards 11 arrangeable by being connected to each other is determined within a range of lengths below the side length of the left long side.

Similarly, an LED board 113d4 is not connected to the LED board 113d3 on the right side of the light guide plate 8, and the maximum number of LED boards 11 arrangeable by being connected to each other is determined within a range of lengths below the side length of the right long side.

Also, like FIG. 8, although not shown, a reflection film which does not leak light to the outside and reflects light into the light guide plate 8 is adhered to the top side and the bottoms of the left and right sides, to which light from the LEDs 12 is not introduced, from among the sides of the light guide plate 8.

### Third Embodiment

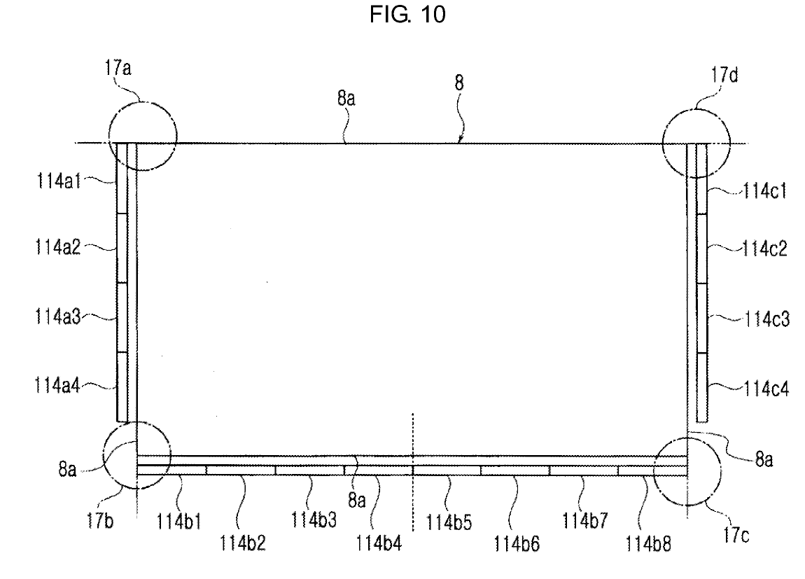

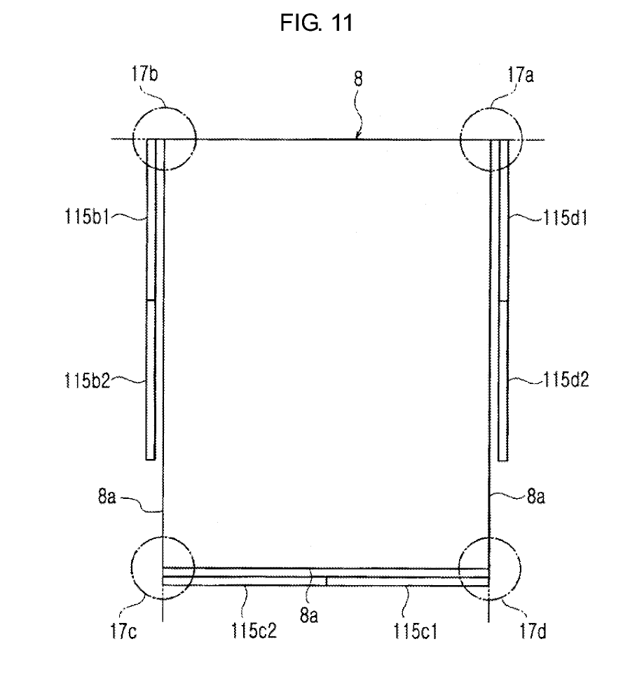

FIGS. 10 and 11 are views of configurations of essential parts according to a third embodiment of the present invention.

In FIG. 10 LED boards 11 (generally denoted by reference numeral 114) on which the LEDs 12 are mounted at equal pitches are arranged facing the end surfaces 8a of side surface portions corresponding to one long side and two short sides of the light guide plate 8.

Also in FIG. 11, LED boards 11 (generally denoted by reference numeral 115) on which the LEDs 12 are mounted at equal pitches are arranged facing the end surfaces 8a of side surface portions corresponding to one short side and two long sides of the light guide plate 8.

Also, in FIG. 10, the light guide plate 8 and the display surface 4a of the liquid crystal panel 4 have a width longer than a length, in which a ratio of a long side to a short side is 16:9, and in FIG. 11, the light guide plate 8 and the display surface 4a of the liquid crystal panel 4 have a length longer than a width, in which a ratio of a long side to a short side is 4:3.

In FIG. 10, LED boards 114a1, 114a2, 114a3, and 114a4 are arranged on the end surface 8a of a side surface portion of a left short side of the light guide plate 8, LED boards 114b1, 114b2, 114b3, 114b4, 114b5, 114b6, 114b7, and 114b8 are arranged on the end surface 8a of a side surface portion of a bottom long side of the light guide plate 8, and LED boards 114c1, 114c2, 114c3, and 114c4 are arranged on the end surface 8a of a side surface portion of a right short side of the light guide plate 8. Since the LED boards 11(114) use the same board, the mounted number and pitch intervals of the LEDs 12 are also the same.

In FIG. 10, eight LED boards 11 are continuously arranged on the entire side length area of the bottom long side of the light guide plate 8, i.e., from an edge portion 17b to an edge portion 17c.

Also, four LED boards 11 are continuously arranged corresponding to ½ (length of four LED boards) of side lengths of long sides on each of the left and right short sides of the light guide plate 8 from points of contacts between the left and right short sides and a top long side where a light source is not arranged, i.e., from an edge portion 17a and an edge portion 17d.

According to the above configuration, an LED board 11 is not arranged on the left side of the light guide plate 8 near the edge portion 17b. Meanwhile, only the LED board 114b1 of the bottom side is arranged on the edge portion 17b.

In detail, an interval in the left side of the light guide plate 8, where an LED board 11 is not arranged near the edge portion 17b, is 1/9 of the entire length of the left side.

Similarly, an LED board 11 is not arranged on the right side of the light guide plate 8 near the edge portion 17c, and only the LED board 114b8 of the bottom side is arranged on the edge portion 17c.

Also, an interval in the right side of the light guide plate 8, where an LED board 11 is not arranged near the edge portion 17c, is 1/9 of the entire length of the right side.

As such, by forming predetermined intervals where an LED board 11 is not arranged near the edge portion 17b and the edge portion 17c, heat concentration due to heat generated by the LEDs 12 does not occur near the edge portions 17b and 17c, and driving efficiency of LEDs near the edge portions 17b and 17c is not deteriorated compared to LEDs in other locations.

Accordingly, since changes of the LEDs 12 to passage of time are made even throughout a backlight, luminance unevenness and color unevenness are not generated in the edge portions 17b and 17c, and thus a product life of the backlight may be increased.

Also, a reflection film which does not leak light to the outside and reflects light into the light guide plate 8 is adhered to the top side and bottoms of the left and right sides, to which light from the LEDs 12 is not introduced, from among the end surfaces 8a of the light guide plate 8.

In FIG. 10, eight LED boards 11 are arranged on a long side and four LED boards 11 are arranged on a short side of the light guide plate 8, but the numbers of LED boards 11 are not limited thereto, and for example, two LED boards 11 may be arranged on a long side and one LED board 11 may be arranged on a short side.

As described above, with respect to four corners of the image display device 50, i.e., four corners of the light guide plate 8 in a backlight device, when the LED boards 11 are arranged on the end surfaces 8a of a long side and two short sides of the light guide plate 8, the LED boards 11 of long or short sides is not arranged, but a predetermined interval is formed on edge portions constituting contact points of the long and short sides of the light guide plate 8.

When the light guide plate 8 and the display surface 4a of the liquid crystal panel 4 have a width longer than a length in an aspect ratio of 16:9 (widthwise arrangement), it is possible to efficiently promote reduction of expenses for manufacturing an LED board by arranging one unit board on a short side, wherein the unit board has a length corresponding to ½ of a side length of the long side.

Also, the one unit board may be divided into a plurality of boards to be applied to an image display device having a large size. When a length of the one unit board is divided, all board lengths may not be the same as shown in FIG. 10, but it is possible to efficiently promote reduction of expenses for manufacturing an LED board when all board lengths are the same.

In FIG. 11, two LED boards 115c1 and 115c2 are continuously arranged on the entire side length area of the bottom short side of the light guide plate 8, i.e., from the edge portion 17c to the edge portion 17d.

Also, two LED boards 11 are continuously arranged corresponding to the side lengths of the short sides on each of the left and right long sides of the light guide plate 8 from the points of contact between the left and right long sides and the top long side where a light source is not arranged, i.e., from the edge portion 17a and the edge portion 17b.

Also, since the LED boards 11(115) use the same board, the mounted number and pitch intervals of the LEDs 12 are also the same.

Accordingly, an LED board 11 is not arranged near the edge portion 17c on the left side of the light guide plate 8. Meanwhile, only the LED board 115c2 of the bottom side is arranged on the edge portion 17c.

In detail, an interval of the left side of the light guide plate 8, where an LED board 11 is not arranged near the edge portion 17c, is ¼ of the entire length of the left side.

Similarly, an LED board 11 is not arranged near the edge portion 17d on the right side of the light guide plate 8, and only the LED board 115c1 of the bottom side is arranged on the edge portion 17d.

Also, an interval of the right side of the light guide plate 8, where an LED board 11 is not arranged near the edge portion 17d, is ¼ of the entire length of the right side.

As such, by forming predetermined intervals where an LED board 11 is not arranged near the edge portion 17c and the edge portion 17d, heat concentration due to heat generated by the LED 12 does not occur near the edge portions 17c and 17d, and driving efficiency of LEDs near the edge portions 17c and 17d is not deteriorated compared to LEDs in other locations.

Accordingly, since changes of LEDs 12 to passage of time are made even throughout a backlight, luminance unevenness and color unevenness are not generated in the edge portions 17c and 17d, and thus a product lifetime of the backlight may be increased.

Also, like FIG. 10, a reflection film which does not leak light to the outside and reflects light into the light guide plate 8 is adhered to the top side and the bottoms of the left and right sides, to which light from the LEDs 12 is not introduced, from among the sides of the light guide plate 8.

In FIG. 11, two LED boards 11 are arranged on each of the long and short sides of the light guide plate 8, but the numbers of LED boards 11 are not limited thereto, and for example, one LED boards 11 may be arranged on each of the long and short sides.

As described above in detail in the first through third embodiments, with respect to four corners of the image display device 50, i.e., the four corners of the light guide plate 8 in the backlight device, when the LED boards 11 are arranged on the end surfaces 8a of both long and short sides of the light guide plate 8, the LED boards 11 of long or short sides is not be arranged, but a predetermined interval is formed on the edge portions constituting the contact points of the long and short sides of the light guide plate 8. Accordingly, the LED boards 11 of any one of long side and short side are not provided at the edge portions of the four corners of the light guide plate 8, and heat concentration at the four corners of the light guide plate 8 due to an LED light source may be resolved. As a result, driving efficiency of the LEDs 12 and durability of the LED boards 11 can be remarkably improved, thereby realizing a long lifetime of the backlight device or image display device 50.

When the light guide plate 8 and a screen size of the display surface 4a have a length longer than a width in the ratio of 4:3 (lengthwise arrangement), one unit board having a length corresponding to the side length of the short sides may be arranged on the long side so as to efficiently promote reduction of expenses for manufacturing an LED board.

Also, the one unit board may be divided into a plurality of boards to be applied to an image display device having a large size. When a length of the one unit board is divided, lengths of the divided board may not be all the same as shown in FIG. 11, but it is possible to efficiently promote reduction of expenses for manufacturing an LED board when lengths of the divided board are all the same.

As such, according to the configurations of the first through third embodiments, i.e., the backlight device and the image display device 50 where a plurality of LED boards 11, on which a plurality of LEDs 12 are mounted, are arranged on the end surfaces 8a of the side surface portions of at least two of long and short sides of the light guide plate 8, the plurality of the LED boards 11 are all the same boards while the predetermined intervals are formed near the edge portions of the contact points of the long and short sides, in which the LED boards 11 are arranged, by continuously arranging the LED boards 11 so as to correspond to the entire side length area of one side of the light guide plate 8 and continuously arranging the LED boards 11 on another side perpendicular to the one side from the point of contact between the another side and the other side which is perpendicular to the another side and on which an LED light source is not arranged, at a length below the another side length. Accordingly, heat quantity of individual LEDs 12 are made uniform, and thus operation temperature conditions of LED light sources are satisfactorily maintained overall.

Also, since heat quantity is not concentrated at the edge portions of four corners of the light guide plate 8 as the backlight, luminance unevenness or a change with respect to passage of time at a local spot is not generated, and thus light emitting efficiency or driving efficiency of the LEDs 12 is not deteriorated, thereby providing the backlight device and image display device 50 having high quality.

Also, since the LED boards 11 are not arranged on the end surface 8a of the light guide plate 8 corresponding to a side where a driving unit or control unit of the liquid crystal panel 4 is arranged, the flexible boards 4f of the liquid crystal panel 4 and the LCD-DRV boards 10 are not affected by deteriorating operation temperature conditions due to heat generated by the LEDs 12, and as a result, it is possible to extend the product lifetime of the image display device 50.

Also, according to the above configurations, it is possible to make the image display device 50 symmetrical while narrowing the edge widths of four sides of the image display device 50 as much as possible, and thus the backlight device and the image display device 50, which are suitable to form a multi-screen by arranging the plurality of image display device 50 up-and-down and right-and-left, can be provided.

Also, in the present invention, the plurality of LED boards 11 on which the plurality of LEDs 12 are mounted are arranged on the end surfaces 8a of side surface portions including at least two of the long and short sides of the light guide plate 8, but since the plurality of LED boards 11 are all the same boards, it is possible to promote reduction of expenses for manufacturing an LED board while the LED boards 11 are applied to an image display device having a large size. Accordingly, the backlight device and the image display device 50 can be provided with a relatively low price where an expense increase of an image display device is suppressed as much as possible.

Also, in the first embodiment, an odd number (5) of LED boards 11 are continuously arranged on the entire side length area of the bottom long side of the light guide plate 8, but the number of LED boards 11 is not limited thereto, and an even number of LED boards 11 may be continuously arranged.

Also, in the second embodiment, an even number of LED boards 11 are continuously arranged on the entire side length area of the bottom short side of the light guide plate 8, but the number of LED boards 11 is not limited thereto, and an odd number of LED boards 11 may be continuously arranged.

Also, in the third embodiment, the light guide plate 8 and the display surface 4a of the liquid crystal panel 4 having a width longer than a length in the ratio of 16:9 or a length longer than a width in the ratio of 4:3 are described in detail, but a length and width ratio is not limited thereto, and may be slightly changed within the scope of the present invention.

Also, in the present invention, since a proportion of a mounted area of the LED boards 11 on the end surface 8a of the light guide plate 8 is increased as much as possible by increasing light-receiving surfaces of the LEDs 12, pitch intervals for mounting the LEDs 12 may be appropriately set, and as a result, it is possible to suppress mounting density of the number of LEDs 12 while suppressing power supply amount to the LEDs 12, thereby highly maintaining light output of individual LEDs 12.

Also, the backlight device and the image display device 50, where luminance of each LED 12 is efficiently obtained and driving efficiency or light emitting efficiency is satisfactorily maintained while desired uniform optical characteristics are obtained throughout the backlight within operation temperature conditions of the image display device 50, can be provided.

Further, since a heat-radiating and insulating structure inside the image display device 50 can be simplified and a plate thickness of the light guide plate 8 can be suppressed, it is possible to suppress increase of the total weight of the image display device 50, and since the light guide plate 8 does not need to have a special shape, transport expenses for transporting each of elements such as the light guide plate 8, the backlight device, and the image display device 50 can be suppressed as much as possible.

Also in the present embodiment, a light source is a white LED, but is not limited thereto, and for example, a single color LED of one of RGB may be arranged.

Also, in the present embodiment, light-receiving surfaces of light sources are on three sides, but the present invention is not limited thereto, and for example, the light-receiving surfaces of the light sources may be on two sides, i.e., one long side and one short side of the light guide plate 8.

According to the present invention, the backlight device and the image display device, where luminance of each LED can be efficiently obtained, driving efficiency or light emitting efficiency of each LED is satisfactorily maintained, and desired uniform optical characteristics are obtained throughout the backlight within a range of operation temperature conditions of the image display device, can be provided. In other words, in the backlight device and liquid crystal display device including the plurality of LED boards (mounting boards) on which the plurality of LEDs (light sources) are mounted on the end surfaces of the side surface portions of the light guide plate, the plurality of LED boards are efficiently arranged by using the same boards, and thus the LED boards are not provided at the edge portions of the four corners of the light guide plate, thereby resolving heat concentration at the four corners of the light guide plate due to the LED light sources. Accordingly, driving efficiency of the LEDs and durability of the LED boards can be improved, thereby realizing long life of the backlight device or image display device.

In detail, according to the backlight device and the image display device, where the plurality of LED boards, on which the plurality of LEDs are mounted, are arranged on the end surfaces of the side surface portions of at least two of long and short sides of the light guide plate, a plurality of the LEDs are all the same boards while the predetermined intervals are formed near the edge portions of the contact points of the long and short sides, in which the LED boards are arranged, by continuously arranging the LED boards so as to correspond to the entire side length area of one side of the light guide plate and continuously arranging the LED boards on another side perpendicular to the one side from the point of contact between the another side and the other side which is perpendicular to the another side and on which an LED light source is not arranged, at a length below the another side length. Accordingly, heat quantity of individual LEDs are made uniform, and thus operation temperature conditions of LED light sources are satisfactorily maintained overall.

Also, since it is possible to promote reduction of expenses for manufacturing an LED board and apply the LED board to an image display device having a large size, the backlight device and the image display device can be provided with a relatively low price where an expense increase of an image display device is suppressed as much as possible.

Further, the backlight device and image display device having high quality can be provided since luminance unevenness or a change with respect to passage of time is prevented from being locally generated as the heat quantity is not concentrated at the edge portions of four corners of the backlight, and since the changes of the liquid crystal module to passage of time are made uniform overall as an LED light source is not arranged on the end surface of one side of the light guide plate of the backlight, where a driver or control unit of a liquid crystal panel is arranged.

Also, since the heat-radiating and insulating structure inside the image display device can be simplified and a plate thickness of the light guide plate can be suppressed, it is possible to decrease the total weight of the image display device and transport expenses for transporting each of elements such as the light guide plate, the backlight device, and the image display device can be suppressed as much as possible.

Also, it is possible to make the image display device symmetrical while narrowing the edge widths of four sides of the image display device, and thus the backlight device and the image display device, which are suitable to form a multi-screen by arranging the plurality of image display device up-and-down and right-and-left, can be provided.

While this invention has been particularly shown and described with reference to exemplary embodiments thereof, it will be understood by those skilled in the art that various changes in form and details may be made therein without departing from the spirit and scope of the invention as defined by the appended claims.

What is claimed is:

1. A backlight device comprising:
a light guide plate having a rectangular shape;
light sources arranged on each of end surfaces of side surface portions formed of long and short sides of the light guide plate; and
mounting board having a long and thin shape and on which the light sources are mounted,
wherein a plurality of mounting boards of a same type are arranged on the long and short sides, and
the plurality of mounting boards are continuously arranged corresponding to the entire area of the end surface of each side of the light guide plate, and at the same time, the mounting boards of any one of long and short sides are not arranged but a predetermined interval is formed at edge portions constituting points of contact between the long and short sides of the light guide plate.

2. A backlight device comprising:
a light guide plate having a rectangular shape;
light sources arranged on each of end surfaces of side surface portions including one long side and one or two short sides of the light guide plate; and
mounting board having a long and thin shape and on which the light sources are mounted,
wherein a plurality of mounting boards of a same type are arranged on the one long side and the one or two short sides, and
the plurality of mounting boards are continuously arranged corresponding to the entire side length area of the one long side.

3. The backlight device of claim 2, wherein the maximum number of mounting boards continuously arrangeable corresponding to a length below a side length of the short side from an edge portion constituting a point of contact between the short side and the other long side where the light sources are not arranged is arranged on the one or two short sides.

4. The backlight device of claim 2, wherein the plurality of mounting boards are continuously arranged corresponding to ½ of a side length of the long side on the one or two short sides from an edge portion constituting a point of contact between the short side and the other long side where the light sources are not arranged.

5. The backlight device of claim 4, wherein a ratio of the long side and the short side is 16:9.

6. A backlight device comprising:
a light guide plate having a rectangular shape;
light sources arranged on each of end surfaces of side surface portions including one short side and one or two long sides of the light guide plate; and
mounting board having a long and thin shape and on which the light sources are mounted,
wherein a plurality of mounting boards of a same type are arranged on the one short side and the one or two long sides, and
the plurality of mounting boards are continuously arranged corresponding to the entire side length area of the one short side.

7. The backlight device of claim 6, wherein the maximum number of mounting boards continuously arrangeable corresponding to a length below a side length of the long side from an edge portion constituting a point of contact between the long side and the other short side where the light sources are not arranged is arranged on the one or two long sides.

8. The backlight device of claim 6, wherein the plurality of mounting boards are continuously arranged corresponding to a side length of the short side on the one or two long sides from an edge portion constituting a point of contact between the long side and the other short side where the light sources are not arranged.

9. The backlight device of claim 8, wherein a ratio of the long side and the short side is 4:3.
